(19) United States
(12) Patent Application Publication
(10) Pub. No.: US 2003/0043435 A1
(43) Pub. Date: Mar. 6, 2003

(54) Method and apparatus for re-acquisition after link disruption in an optical wireless link

(76) Inventors: Eric Gregory Oettinger, Rochester, MN (US); Mark David Heminger, Rochester, MN (US); Karl Kirk Northrup, Rochester, MN (US)

Correspondence Address: TEXAS INSTRUMENTS INCORPORATED, P O BOX 655474, M/S 3999, DALLAS, TX, 75265

(21) Appl. No.: 09/942,265

(22) Filed: Aug. 27, 2001

(51) Int. Cl. H04B 10/00

(52) U.S. Cl. 359/159; 359/172

(57) ABSTRACT

Optical wireless links automatically re-acquire alignment after detecting the loss of an incoming signal bearing light beam. The loss of the signal may be due to a temporary blockage of the light path, so the devices will await a programmable period of time before attempt to re-align themselves. If re-alignment is required, the devices will first position their light beams to the last known aligned position and will from that point sweep through a pattern seeking to re-align with the remote device. The devices transmit their beam position information during the sweep, which information will be echoed back or fed back to the device once its beam impinges upon the remote devices photodetectors. If the devices cannot re-align, then a second, longer sweep pattern may be performed, starting at some predefined default location.

### CROSS REFERENCE TO RELATED APPLICATION

The following co-pending, co-assigned patent applications are related to the present invention. Each of the applications is incorporated herein by reference.

| Serial No. | Filing Date | Attorney Docket |
|---|---|---|
| 09/621,385 | 7/21/2000 | TI-30713 |
| 09/620,943 | 7/21/2000 | TI-30714 |
| 60/234,074 | 9/20/2000 | TI-31437 |
| 60/234,086 | 9/20/2000 | TI-31436 |
| 60/234,081 | 9/20/2000 | TI-31444 |
| 60/233,851 | 9/20/2000 | TI-31612 |
| 60/271,936 | 2/26/2001 | TI-32675 |
| 09/839,690 | 4/20/2001 | TI-31429 |
| 09/923,510 | 8/6/2001 | TI-31440 |
| 60/285,461 | 4/20/2001 | TI-32924 |

### FIELD OF THE INVENTION

This invention relates generally to optical wireless communications, and more specifically, to re-acquisition of self-alignment for optical wireless links using positional feedback across the optical wireless channel.

### BACKGROUND OF THE INVENTION

Modern data communications technologies have greatly expanded the ability to communicate large amounts of data over many types of communications facilities. This explosion in communications capability not only permits the communications of large databases, but has also enabled the digital communications of audio and video content. This high bandwidth communication is now carried out over a variety of facilities, including telephone lines (fiber optic as well as twisted-pair), coaxial cable such as supported by cable television service providers, dedicated network cabling within an office or home location, satellite links, and wireless telephony.

Each of these conventional communications facilities involves certain limitations in their deployment. In the case of communications over the telephone network, high-speed data transmission, such as that provided by digital subscriber line (DSL) services, must be carried out at a specific frequency range to not interfere with voice traffic, and is currently limited in the distance that such high-frequency communications can travel. Of course, communications over “wired” networks, including the telephone network, cable network, or dedicated network, requires the running of the physical wires among the locations to be served. This physical installation and maintenance is costly, as well as limiting to the user of the communications network.

Wireless communication facilities of course overcome the limitation of physical wires and cabling, and provide great flexibility to the user. Conventional wireless technologies involve their own limitations, however. For example, in the case of wireless telephony, the frequencies at which communications may be carried out are regulated and controlled. Furthermore, current wireless telephone communication of large data blocks, such as video, is prohibitively expensive, considering the per-unit-time charges for wireless services. Additionally, wireless telephone communications are subject to interference among the various users within the nearby area. Radio frequency data communication must also be carried out within specified frequencies, and is also vulnerable to interference from other transmissions. Satellite transmission is also currently expensive, particularly for bi-directional communications (i.e., beyond the passive reception of television programming).

A relatively new technology that has been proposed for data communications is the optical wireless network. According to this approach, data is transmitted by way of modulation of a light beam, in much the same manner as in the case of fiber optic telephone communications. A photoreceiver receives the modulated light, and demodulates the signal to retrieve the data. As opposed to fiber optic-based optical communications, however, this approach does not use a physical wire for transmission of the light signal. In the case of directed optical communications, a line-of-sight relationship between the transmitter and the receiver permits a modulated light beam, such as that produced by a laser, to travel without the waveguide of the fiber optic.

It is contemplated that the optical wireless network according to this approach will provide numerous important advantages. First, high frequency light can provide high bandwidth, for example ranging from on the order of 100 Mbps to several Gbps, using conventional technology. This high bandwidth need not be shared among users, when carried out over line-of-sight optical communications between transmitters and receivers. Without the other users on the link, of course, the bandwidth is not limited by interference from other users, as in the case of wireless telephony. Modulation can also be quite simple, as compared with multiple-user communications that require time or code multiplexing of multiple communications. Bi-directional communication can also be readily carried out according to this technology. Finally, optical frequencies are not currently regulated, and as such no licensing is required for the deployment of extra-premises networks.

These attributes of optical wireless networks make this technology attractive both for local networks within a building, and also for external networks. Indeed, it is contemplated that optical wireless communications may be useful in data communication within a room, such as for communicating video signals from a computer to a display device, such as a video projector.

It will be apparent to those skilled in the art having reference to this specification that the ability to correctly aim the transmitted light beam to the receiver is of importance in this technology. Particularly for laser-generated collimated beams, which can have quite small spot sizes (i.e. cross sectional area), the reliability and signal-to-noise ratio of the transmitted signal are degraded if the aim of the transmitting beam strays from the optimum point at the receiver. Especially considering that many contemplated applications of this technology are in connection with equipment that will not be precisely located, or that may move over time, the need exists to precisely aim and controllably adjust the aim of the light beam.

Co-pending application Ser. No. 09/310,284, filed May 12, 1999, entitled “Optical Switching Apparatus”, commonly assigned herewith and incorporated herein by this reference, discloses a micro-mirror assembly for directing a light beam in an optical switching apparatus. The micro-mirror reflects the light beam in a manner that may be precisely controlled by electrical signals. The micro-mirror assembly includes a silicon mirror capable of rotating in two axes. One or more small magnets are attached to the micro-mirror itself; a set of four coil drivers are arranged in quadrants, and are current-controlled to attract or repel the micro-mirror magnets as desired, to tilt the micro-mirror in the desired direction.

Because the directed light beam, or laser beam, has an extremely small spot size, precise positioning of the mirror to aim the beam at the desired receiver is essential in establishing communication. This precision positioning is contemplated to be accomplished by way of calibration and feedback, so that the mirror is able to sense its position and make corrections.

Co-pending patent application Ser. No. 09/620,943 entitled “Optical Wireless Link,” commonly assigned herewith and incorporated herein by reference, discloses one approach to providing a feedback signal from the receiver to the transmitter over a secondary link. As disclosed in the application, the feedback and control signals are transmitted over a low bandwidth link, such as a radio frequency (RF) link or a twisted pair or similar physical link.

Another approach to providing a light beam alignment feedback signal to the transmitter is disclosed in co-pending patent application 60/234,081 entitled “Optical Wireless Networking with Direct Beam Pointing,” commonly assigned herewith and incorporated herein by reference. In that application, alignment feedback is provided passively by a receiver lens surrounded by a retro-reflective annulus.

As optical wireless links become more prevalent, users will demand greater autonomy in the devices as they are deployed in networks and real-world environments. One area of autonomy that will be expected of such devices is the ability to automatically acquire the signal of a remote link in order to establish the optical wireless communication channel between them. Co-pending, commonly assigned patent application TI-32924, entitled “Method and Apparatus for Aligning Optical Wireless Links” and incorporated herein by reference provides an approach to automatically acquire alignment between two optical wireless devices.

In a typical operating environment, the optical path between two optical wireless links can be disrupted due to an obstacle blocking the path, due to the malfunction of one or the other device, or due to a loss of alignment arising from one or both of the devices being moved, bumped, or displaced in some way. Therefore, a need exists in the art for an optical wireless link that can automatically re-acquire a line-of-sight communication with another optical wireless link in a way that is most efficient depending upon the reason for the loss of the optical path.

### SUMMARY OF THE INVENTION

In one aspect, the present invention provides for a method of re-acquiring alignment of an optical wireless device, the optical wireless device transmitting information over a light beam and storing orientation information for a last known good alignment position for the light beam. The method comprises detecting a disruption of reception of an information transmitting light beam, when the light beam is at a first alignment position, positioning the light beam to the last known good alignment position, sweeping the light beam through a first pre-defined re-acquisition pattern, and periodically transmitting position information over the light beam during the sweeping step.

In another aspect the present invention provides for an optical wireless link comprising a light beam transmitter, configured to transmit an information bearing light beam, a light beam steering device coupled to the light beam transmitter, and a light beam orientation detector coupled to the light beam transmitter and the light beam steering device and configured to detect the alignment of the light beam. The device further comprises a photodetector configured to detect an incoming information bearing light beam, a memory coupled to the light beam orientation detector and configured to store last known good alignment position data, and control circuit coupled to the photodetector and the light beam steering device. The light beam steering device will position the light beam to the last known good alignment position in response to the photodetector detecting the disruption of the incoming information bearing light beam and will further sweep the light beam through a pre-defined re-acquisition pattern starting at the last known good alignment position. The light beam transmitter control circuit will periodically transmit light beam alignment position information received from the light beam position detector while the light beam is swept through the pre-defined re-acquisition pattern.

In yet another aspect, the invention provides for a method of re-acquiring alignment between two optical wireless links comprising detecting at a first optical wireless link and a second optical wireless link the disruption of a first and second incoming light beam, respectively, positioning the first light beam to a last known good alignment position for the first light beam and the second light beam to a last known good alignment position for the second light beam, and sweeping the first and second light beams through a re-acquisition alignment pattern while transmitting position information for the first and second light beams over the first and second light beams, respectively. Upon detecting the first light beam at the second optical wireless device, transmitting the position information received from the first optical wireless device back to the first optical wireless device as a first updated last known good alignment position. Upon detecting the second light beam at the first optical wireless device, transmitting the position information received from the second optical wireless device back to the second optical wireless device as a second updated last known good alignment position. The method further comprises aligning the first and second light beams to the first and second updated last known good alignment positions, respectively, method of.

### BRIEF DESCRIPTION OF THE DRAWINGS

The above features of the present invention will be more clearly understood from consideration of the following descriptions in connection with accompanying drawings in which:

FIG. 1 illustrates a preferred embodiment wireless optical communication system;

FIG. 2 illustrates the field of view of a preferred embodiment optical wireless link;

FIGS. 3a and 3b provide further details schematically of an optical wireless link embodying features of the present invention;

FIG. 4 illustrates a control packet for transmitting alignment information in a preferred embodiment system;

FIGS. 5a and 5b provide further details of the control packet;

FIG. 6 is a flow diagram of a preferred embodiment method of the present invention;

FIG. 7 schematically illustrates a first preferred embodiment re-acquisition alignment pattern; and

FIG. 8 illustrates a second preferred embodiment re-acquisition alignment pattern; illustrates further details of a preferred embodiment acquisition pattern;

FIG. 9 schematically illustrates a preferred embodiment optical module; and

FIG. 10 schematically illustrates a series of scan patterns having different boundary sizes.

### DETAILED DESCRIPTION OF ILLUSTRATIVE EMBODIMENTS

The making and use of the various embodiments are discussed below in detail. However, it should be appreciated that the present invention provides many applicable inventive concepts, which can be embodied in a wide variety of specific contexts. The specific embodiments discussed are merely illustrative of specific ways to make and use the invention, and do not limit the scope of the invention.

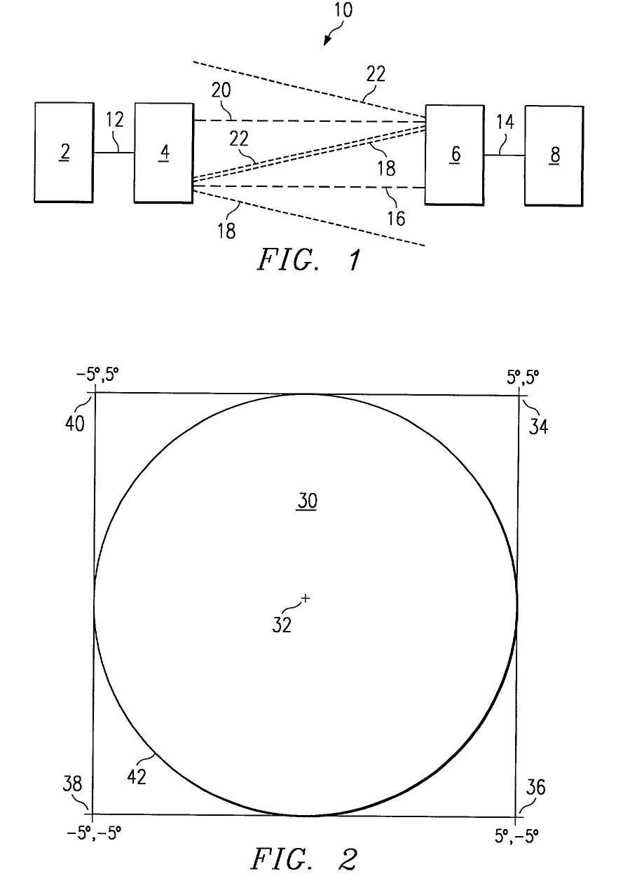

FIG. 1 illustrates a preferred embodiment optical wireless system 10, including a first data source/ sink 2 connected to a first Optical Wireless Link (“OWL”) 4. The OWL 4 can both transmit to and receive data from a second OWL 6 over a wireless optical path. OWL 6 is in turn connected to a second data sink / source 8. Preferably each OWL device is an optical path-to-sight modem. As used herein, the term path-to-sight is intended to mean an unobstructed optical path generally through the ether, as contrasted with through an optic fiber, which path can include reflection. An advantageous feature of the OWL devices is that the optical beam is a narrow, collimated light beam, such as provided by a laser or collimated laser diode. The narrow beam allows for a lower power laser source to be used, because the optical power is concentrated in a small area. While this provides an advantage in terms such as eye safety and lower power consumption, it provides a commensurate disadvantage that it is difficult to align the collimated light beam to the receiving photodetector (because of the relatively small beam size). This disadvantage becomes more pronounced as the distance between the two OWLs increases, because a small angular misalignment becomes more pronounced as the overall beam length is increased.

Data sink/ sources 2, 8 could be any type of data device, such as a computer, a LAN network, an Ethernet device, a telephony device or switch, and the like. Data sink / sources 2, 8 communicate with OWLs 4, 6, respectively over a data connections 12, 14, respectively. These data connections (e.g., twisted pair, cable, fiber optic) are typically physical connections operating under a standard protocol, such as Ethernet, TCP/IP, ATM, and the like. Data connections 12, 14 could also be RF based wireless connections in some applications.

OWL 4 communicates with OWL 6 over a collimated light beam 16. OWL 4 has a field of view 18 and the receiver of OWL 6 must be positioned within the field of view 18 for effective communication. Likewise, OWL 6 has a field of view 22 in which it can transmit a collimated light beam 20 to the receiver of OWL 4. As described in greater detail in co-pending patent applications Ser. No. 09/620,943, signal to noise ration (SNR) is maximized when the light beams 16, 20 are centered on the photo-receivers of the receiving units 6, 4, respectively. The alignment of the light beam can be detected as a function of received optical power, signal intensity, and the like and this detected alignment information can then be fed back to the transmitter. Also described in greater detail in co-pending patent application Ser. No. 09/620,943 is a preferred embodiment mechanism for controllably steering the light beam. In addition to or from data from data source / sink 8, OWL 6 transmits the light beam alignment feedback signals to OWL 4 over light beam 20. Likewise, OWL 4 transmits beam alignment feedback signals to OWL 6 over its light beam 16, in addition to data to or from data source / sink 2. Because light beams 16, 20 are high bandwidth, low latency paths, the transmission of feedback signals over the beams allows for rapid alignment of the beams (low latency) without degrading the data handling capabilities of the system (high bandwidth). In the preferred embodiments, OWL devices 4 and 6 communicate with each other using standard 100 Mb/s Ethernet protocol. The inventive concepts described herein apply equally to other communication protocols, including ATM, TCP/IP, SONET, IEEE 1394, IRDA, 10 Mb/s Ethernet, Gigabit Ethernet, and other alternatives within the purview of one skilled in the art.

In the preferred embodiments, OWL 4 and OWL 6 are mounted to respective fixtures for operation. Examples of fixture might include affixing an OWL within the housing of a personal computer, mounting an OWL to a wall with a bracket, positioning an OWL on a counter-top, desk-top, or other work surface, mounting the OWL on a cubicle wall, and the like. The primary requirement for the fixture is that it affixes the OWL relatively stably in the proper position vis-à-vis another OWL with which it is desired to communicate over line-of-sight beams 16 and 22. A first level of alignment is provided by positioning the OWLs 4 and 6 in their respective fixtures such that the two devices have their beam transmitters generally pointing toward each other, as shown in FIG. 1. Although a fixture is preferable in order to minimize the likelihood that the OWL will be moved out of alignment, it is not necessary for the teachings of the present invention that a fixture be employed. In some embodiments, the OWL will be simply placed on a work surface and pointed in the direction of a remote OWL. One skilled in the art will recognize that care should be taken to ensure that the OWL will not be unduly disturbed or moved during operation.

In the preferred embodiments, each OWL has beam steering capability providing a field of view 30 of ten degrees in both an x axis and a y axis, as shown in FIG. 2. The neutral, or default position for the light beam is in the center of the field of view, as indicated by point 32. The beam can be deflected as much as five degrees along the x axis, in either direction, and as much as five degrees in either direction along the y axis. Hence, point 34 illustrates the beam having been deflected five degrees positively along the x axis and five degrees positively along the y axis. Point 36 illustrates where the light beam would point when it is deflected five degrees positively along the x axis and five degrees negatively along the y axis. Likewise, point 38 illustrates where the light beam would point when it has been deflected five degrees negatively in both the x and y axes, and point 40 illustrates the beam having been deflected five degrees negatively in the x axis and five degrees positively in the y axis. Of course, the beam could be deflected less than five degrees in either direction, and hence the beam could be deflected to point anywhere within the field of view 30.

Also shown in FIG. 2 is the field of view 42 of receiving OWL 6. This represents the area for which the photodetector of the receiving OWL can detect an incoming light beam. Because the photodetector of receiving device has a round field of view, the light beam deflection will preferably be limited to the round area 42.

The details of a method and apparatus for acquiring initial alignment between OWLs 4 and 6 in order to establish communication between them is disclosed in co-pending patent application docket number TI-32924. The present invention will be described in the context of preferred embodiment methods and systems for re-acquiring communication and/or alignment between two devices in a rapid and efficient manner. One advantageous feature of the preferred embodiments is the ability to adaptively select the appropriate re-acquisition procedure based upon the likely cause of the disruption in communications.

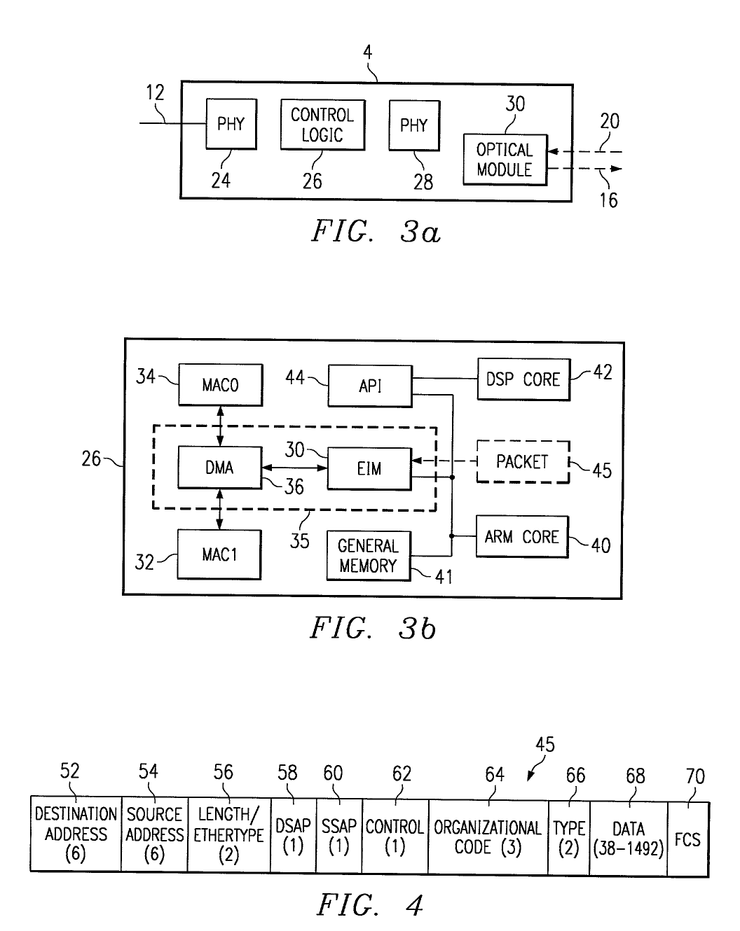

FIG. 3a provides further details for OWL 4. The following discussion applies equally to OWL 6. Data originating from data source / sink 2 and coming in over data connection 12 is received by PHY 24 where the data is converted from a serial format to a four bit parallel (MII) format, as is well known in the art. PHY 24 is a physical format converter that receives data in the format particular to the physical data connection to which it is attached and converts it into a media independent interface (MII) format that is not specific to a physical connection. From PHY 24, the data is passed to control logic 26 where the data may be encoded or decoded, supplemented with Operation / Administration / Maintenance (OAM) data, formatted for further transmission, enclosed within an appropriate network packet, or other data handling as is well known in the art. In addition, control logic 26 will read from the data stream certain control packets for light beam alignment, as will be discussed in greater detail below. A second PHY device 28 receives the data from control logic 26 and converts is from the parallel MII format into a serial format specific to optical data transmission. In the preferred embodiments, PHY 28 converts the data to a standard physical layer protocol for fiber optic transmissions (e.g., 100Base-FX or SX). Other physical layer protocols, or a specialized optical wireless protocol could also be used. The data is then passed to optics module 30, where it is converted from an electrical format to an optical format and transmitted over light beam 16 to OWL 6, from where it will be transmitted to the appropriate destination such as data sink / source 8 by way of data connection 14.

OWL 4 operates as a receiver as well, in which case the data path is the opposite of that just described. Data from data sink / source 8 is processed by OWL 6 in the manner described above and transmitted optically to OWL 4 via modulated light beam 20. Optical module 30 detects the modulated light beam, converts it to an electrical signal, and passes the electrical signal to control logic 26. Control logic 6 inspects the incoming signal and reads from it any control packets relating to beam alignment feedback, as discussed in greater detail below. The data stream is passed from control logic 26 to PHY 24 where it is converted to the appropriate physical format for transmission to data sink / source 2 over data connection 12.

Further details of control logic 26, including the details of insertion and extraction of alignment feedback control signals will now be provided with reference to FIG. 3b. In the preferred embodiment, control logic 26 comprises a TMS320VC5472 IP processor, available from Texas Instruments, Dallas, Tex., although the following described features could be embodied in discrete devices, other integrated components, specialized hardware, or general purpose hardware running under appropriate software control. Control logic 26 includes media access controller (MAC) 32, which is connected to PHY 24 (FIG. 2) and a second MAC 34 connected to PHY 28. As is well known in the art, the MACs have individual Ethernet addresses and are hence network addressable at the Ethernet protocol level. Connected between the MACs is an Ethernet switch 35 comprising direct memory access (DMA) 36 and Ethernet interface module (EIM) 38. The Ethernet switch 35 is responsible for detecting and extracting feedback control packets from the data stream as well as for inserting feedback control packets into the data stream. Feedback control packets are detected by Ethernet switch 35 on the basis of the Ethernet destination address contained within the packet, as will be discussed in greater detail below. Control packets are inserted into the data stream by storing incoming packets or frames of data in a buffer, and inserting a control packet between the data packets or frames, under the control of advanced RISC processor (ARM) core 40.

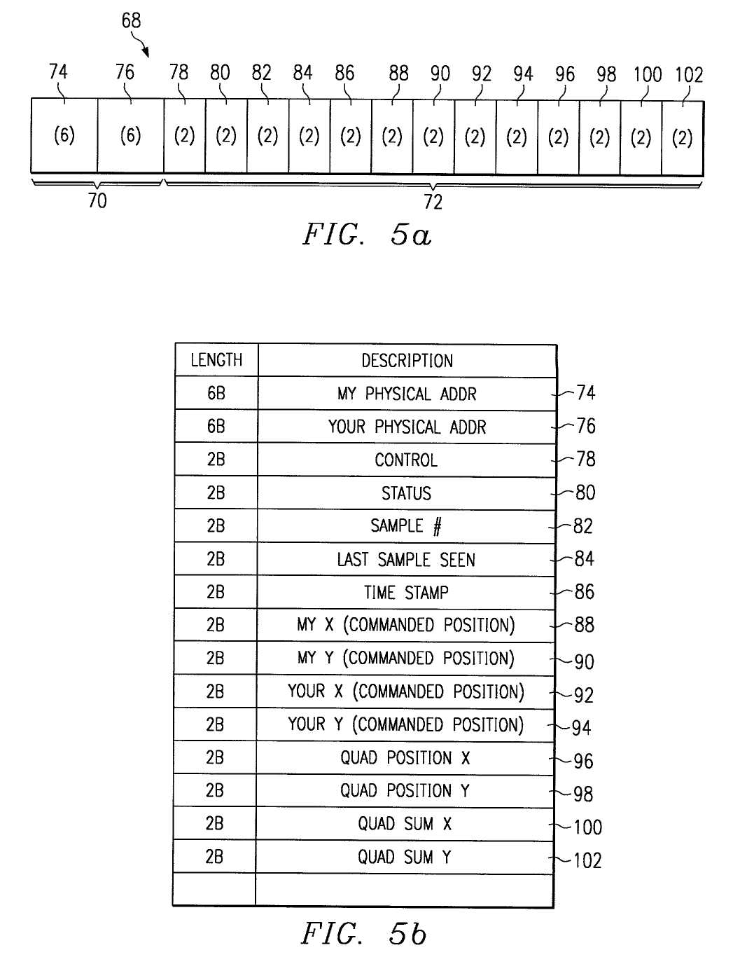

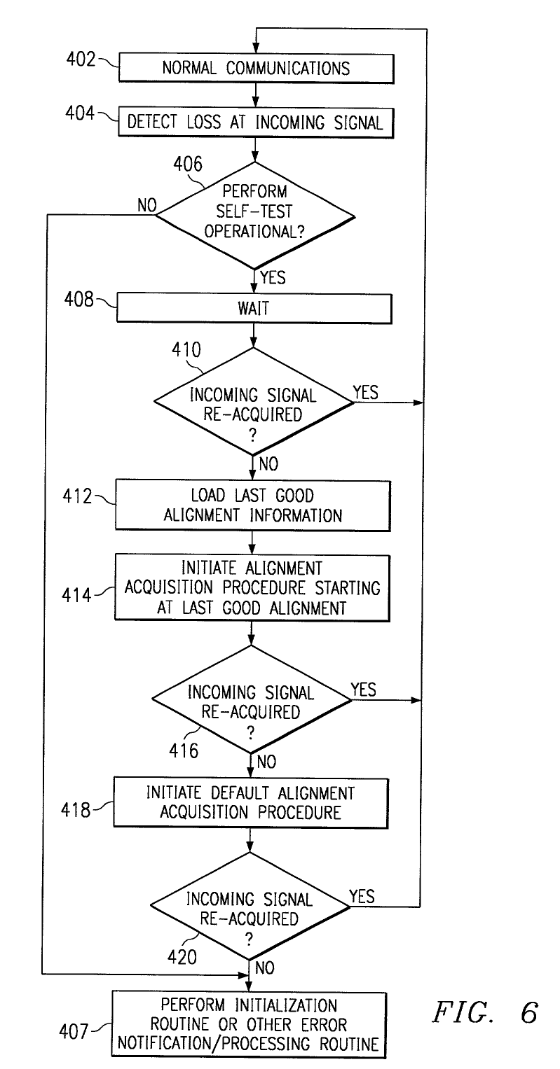

Referring again to FIG. 1, during operation, OWL 4 will have its light beam 16 aligned to the photodetector of OWL 6 and OWL 6 will have its light beam 20 aligned to the photodetector of OWL 4. As discussed in greater detail in co-pending patent application docket number TI-31440, both OWL 4 and OWL 6 will periodically transmit a control packet containing beam alignment information to the other OWL device. FIG. 4 illustrates an exemplary control packet 45 having various fields for identifying the source of the packet, the destination for the packets, control fields, identification fields, and the like, and a data field 68. FIGS. 5a and 5b provide further details for the data field 68. Note in particular that data field 68 includes beam alignment and positioning information, such as “My X” and “My Y” fields 88 and 90, respectively relating to the orientation of the beam of the device that transmitted the control packet as well as “Your X” and “Your Y” fields 92 and 94, respectively, containing orientation information for the beam that was received by the transmitting device from the other device. Also included is additional alignment such as “Quad Position X” field 96 and “Quad Position Y” field 98 and other fields that are used for aligning the light beams during an initial alignment acquisition procedure, as discussed in greater detail in co-pending application docket number TI-31924. These beam orientation and alignment field values 74 through 102 are stored in memory in OWL 4 (and the corresponding values for OWL 6 are stored in the memory of OWL 6). In a preferred embodiment, the values are stored in general memory 41, as shown in FIG. 3. In other embodiments, the alignment and orientation information could be stored in special purpose registers, in non-volatile memory cells, on a hard disk drive or other magnetic storage or optical medium, or the like.

In the following discussion, it is assumed that OWLs 4 and 6 have been aligned to one another and have begun to transmit data between them, such as data originating at data source / sink 2 and destined for data source sink 8. It is further assumed that at some point during operation, communication between the OWLs has ceased because one or both of the devices has stopped receiving the modulated light beam of the other device. The following discussion will be in the context of OWL 4 having “lost” the light beam of OWL 6, although the teachings apply equally to OWL 6 having “lost” the light beam of OWL 4, or both OWLs having lost alignment with the incoming beam.

FIG. 6 provides a flow chart for the sequence of operations OWL 4 will perform, beginning at step 402 at which time OWL 4 is receiving incoming communications over light beam 20 from OWL 6. As shown as step 404, OWL 4 will detect the loss of the incoming signal, should such event occur. OWL 4 could detect the loss of the incoming signal in several ways; by the absence of data coming over the light beam, or by the absence of control packets 45 coming over the light beam, or by the absence of a “heart beat” signal that may be regularly transmitted by OWL 6, or preferably by the drop in light intensity (of the relevant wavelengths) being received at the photodetector of OWL 4.

In some embodiments, OWL 4 will perform a self-test procedure to ensure that the absence of a received signal is not due to some internal malfunction. The various electronic and mechanical components of the device could be queried or exercised in some way to ensure their operational status. As indicated by decision step 406, OWL 4 will perform some error-handling routine. This routine could be an error notification task whereby OWL 4 will send an error message over data connection 12 (FIG. 1) to a network manager. In some embodiments, OWL 4 may have internally stored error handling routines to address certain types of errors that might have been identified in the self-test operation. In yet other embodiments, OWL 4 might simply re-initialize itself if the self-test reveals some non-operational status.

Assuming that the self-test revealed that OWL 4 was operational, processing would continue to step 408. At this point OWL 4 will preferably wait for some pre-defined period of time before commencing further. This is in recognition that the line-of-sight path between OWLs 4 and 6 is subject to blockage from various environmental factors unrelated to beam alignment. For instance, in an office environment, a person walking between the two devices might temporarily block the light beams 16 and 20 (note that in most applications, it is assumed that the OWLs will be positioned that their line-of-sight is high enough or otherwise positioned to minimize such interference). In an outdoors environment (typically the OWLs will be mounted on building rooftops), the light paths might be temporarily blocked by wind-blown debris, a bird flying past, and the like. It is anticipated that whatever the cause of the blockage, (i) it will be relatively short-lived, i.e. on the order of only a few seconds, and (ii) it will nonetheless be detected because the light beams are operating at 100 Mb/s or greater data bandwidths. At such high data bandwidths, even a second or two can cause significant data loss. An advantageous feature of the preferred embodiments is that the device recognizes that possibility that the light beams may simply be temporarily blocked and performs the wait operation 408 to accommodate this, rather than immediately engaging in the following described re-acquisition process. Assuming the re-acquisition process takes on the order of fifteen to twenty seconds, and further assuming the wait operation 408 is configured to pause for, say, five seconds in order to see if the signal blockage is removed, a significant reduction in recovery time is accomplished.

In some embodiments, the period of wait time for step 408 is a static period. In other embodiments, the wait time can be dynamic, depending upon several factors. The wait period can be extended or reduced as a function of network traffic, or light beam reliability. A historical analysis of previous beam interruption time periods can be tracked and the wait period adjusted accordingly. In yet other embodiments, the wait period could be defined as a function of time. For instance, it might be known that during working hours, it is likely that loss of signal is due to a person obstructing the beam paths, whereas after hours, loss of signal is more likely due to the devices having become misaligned somehow (e.g. from the devices being vibrated, or bumped, or inadvertently moved somehow).

After waiting the pre-defined period of time, OWL 4 will determine whether the incoming light signal has been re-acquired. If so, processing can return to normal operations step 402. One skilled in the art will recognize that some steps will likely be required to notify the sending device (in this case OWL 6) to re-send data that might have been transmitted while the light signal was lost.

Assuming the incoming signal was not re-acquired after the wait period, OWL 4 will enter into the second phase of the re-acquisition mode. This phase involves sweeping the light beam through a pre-defined pattern to attempt to re-align the light beam to OWL 6. Because OWL 4 is not receiving a signal from OWL 6 at this point, it has no way of knowing whether the mis-alignment is due to OWL 4 becoming mis-aligned or due to OWL 6 becoming mis-aligned or both. As such, OWL 4 will “assume” it is no longer aligned and will begin the re-acquisition beam sweep. Presumably, OWL 6 will be performing a similar operation to re-acquire the signal from OWL 4 as well.

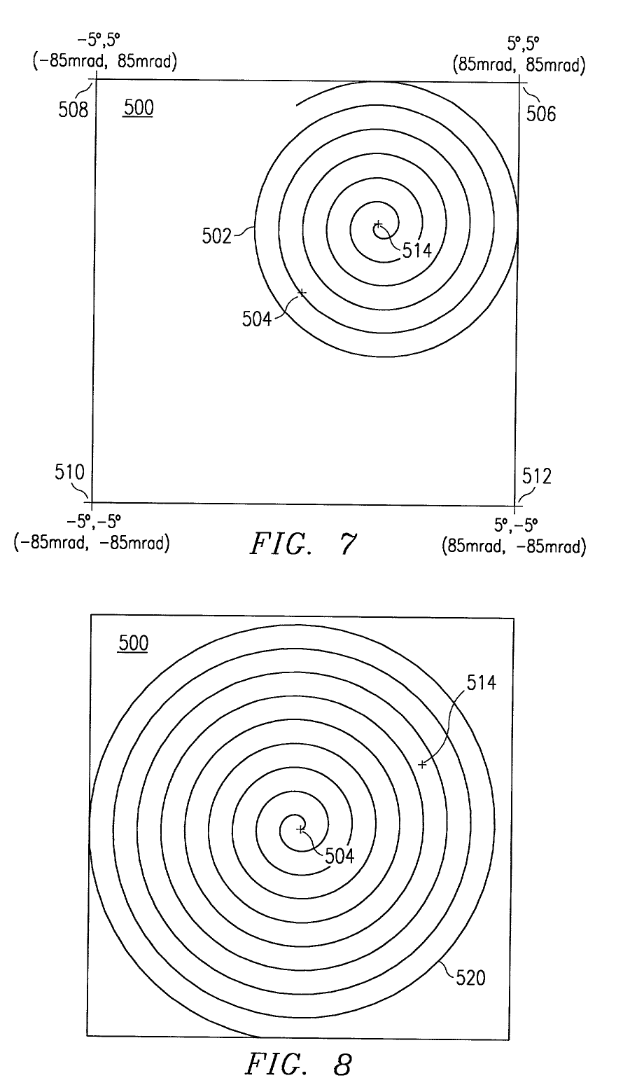

In order to increase the likelihood of re-aligning light beam 16 and to minimize the time required to do so, OWL 4 will begin its re-acquisition sweep at the point where the light beam was last in alignment. This is shown in step 412 where the Last Good Alignment Information is retrieved. This information is preferably stored in system memory but, as described above, could otherwise be stored in a special purpose register or on some magnetic or optical storage medium. As indicated by step 414, the light beam is then swept through the pre-defined pattern, starting at the orientation defined by the Last Good Alignment information. This is further illustrated in FIG. 7, which schematically illustrates a preferred embodiment sweep pattern 502 in the field of view 500 of OWL 4.

As shown, OWL 4 has a field of view in which its light beam can be transmitted, the field of view having ten degrees in both the x and y axes. Relative to the center of the field of view 504 (the “default alignment position”), the light beam can be steered to any point in the square field of view 500. At the extremes, the light beam can point degrees above and five degrees to the right of the center point, i.e. at corner 506, five degrees above and five degrees to the left of the center point, corner 508, five degrees below and five degrees to the left of the center, corner 510, or five degrees below and five degrees t the right of the center point, corner 512. The light beam can also be pointed in any other intermediate point within the field of view 500. In the preferred embodiments, the light beam position information is calculated in terms of mili-radians (mrad), rather than degrees. Hence, the field of view 500 covers plus or minus 85 mrad in either direction (1 mrad =1/17 degree).

As discussed above, prior to the disruption of the signal, the light beam 16 was aligned to OWL 6 by being oriented somewhere within the field of view 500. An exemplary Last Good Alignment orientation point is shown at 514 is FIG. 7. Point 514 is located at coordinates 20 mrad, 40 mrad, meaning the beam was aligned when it was oriented 20 mrad to the right and 40 mrad above the center 504 of the field of view 500. Alternatively, the beam position could be tracked in terms of radius and angle coordinates, or some other coordinate system, in lieu of Cartesian coordinates. Even though alignment with the remote device has been lost, the chances are good that the re-alignment point is located not too far from the Last Good Alignment point. For instance, if either OWL 4 or OWL 6 had been jarred slightly, than an adjustment of only a few mrad along one or both axes may be necessary to re-align the devices. Therefore, OWL 4 will position the beam to point 514 and from that point it will begin to sweep the beam though a re-acquisition pattern, such as the expanding spiral pattern 502 shown in FIG. 7.

While the beam is being swept through the re-acquisition pattern, OWL 4 will periodically transmit a control packet 45 containing, among other data, the beam position coordinates. Note that at this point, no actual data (i.e. from or to data sink / source 2) will be transmitted over the light beam because the signal has been lost. In the preferred embodiment, beam 16 will be swept from point 514 in a spiral pattern centered on point 514 and then back to point 514, all the while sending the control packets containing alignment data. Preferably, the maximum radius of the first spiral pattern is on the order of 10 mrad, significantly smaller than the entire transmitter field of view, as this pattern covers the positions nearest the Last Good Alignment position most likely to contain the realignment position for small jarring events. The maximum radius for successive spirals is gradually increased until the pattern reaches the edge of the transmitter field of view. This is illustrated in FIG. 10, wherein the size of a first spiral scan pattern is shown within the boundary 602. A subsequent, larger scan within boundary 604 is then performed is the scan within boundary 602 was not successful. If the scan within boundary 604 was not successful, then a next larger boundary scan, 606, will be performed. Eventually, the scan boundary will increase large enough to cover the entire filed of view 500 or the OWL will transition to a scan pattern starting at the default location 504 and will scan across the entire field of view 500.

After the beam has been swept through pattern 502 (at least once and possibly several times), OWL 4 will again determine whether the incoming signal has been re-acquired, in the same manner as discussed above, as indicated by step 416. If the signal has been re-acquired, OWL 4 returns to normal data communications operation 402, as discussed above. If the signal has not been re-acquired, then processing continues to step 418 where a second re-acquisition sweep pattern will be performed. This second sweep pattern is illustrated in FIG. 8. As shown, the beam is swept through a second spiral pattern originating at the center 504 and extending outward to the edge of field of view 500, and then spiraling back inward to center point 504. Note that, in contrast to pattern 502, which covers only a portion of the field of view, pattern 520 covers the entire field of view. Hence, if alignment was not re-acquired at step 414, then it may be re-acquired in step 418. The chances that alignment will be re-acquired in sweep pattern 502 are greater, however (because this pattern centers on the Last Known Good alignment position), so it makes sense to try to re-align using pattern 502 first (for expediency).

After the beam has been swept through second re-acquisition pattern 520 (at least once, and possibly several times), OWL 4 once again determines whether the incoming signal has been re-acquired. If so, processing continues to normal communications operations 402. If not, then the cause of the signal disruption is either not due to beam alignment, or the mis-alignment is so great that OWL 6 is not longer with the field of view of OWL 4, or OWL 4 is no longer within the field of view of OWL 6, or both.

Many modifications to the above described embodiments are within the scope of the present invention. For instance, other sweep patterns, such as a raster scanning pattern, a square spiral and the like could be employed. The advantageous feature of the spiral scan pattern, however, is that the pattern is free of sudden discontinuities in position and its derivatives. Such discontinuities can excite resonance in the mechanical structure of the micro-mirror (or other beam steering device) or its mounting, leading to undesirable oscillations. Therefore, even though other scan patterns are within the scope of the present invention, including linear raster scanning, a square spiral patterns, and the like, care must be taken to minimize the effects of directional or positional discontinuities in such embodiments.

In the above described embodiments, the alignment information was fed back to the transmitting OWL in terms of x and y coordinates (“My X” and “My Y” and “Your X” and “Your Y” fields). Additionally or alternatively, the alignment information can be fed back in other ways. For instance, the preferred control packet 45 contains a “Time Stamp” field 86 (FIG. 5b). This Time Stamp can be an absolute time value, or a time value relative to some arbitrary time reference point. Upon receiving a control packet from a first transmitting OWL, the second receiving OWL can return the Time Stamp value back to the first OWL during its acquisition scan. When the first OWL receives the control packet from the second OWL, it will include the Time Stamp that indicates the point in time in which the first OWL was aligned to the second OWL. Because the first OWL knows the amount of time elapsed since the Time Stamp time, and knows the sweep pattern of its beam, the first OWL can re-align its beam to the position it was at at the time of the Time Stamp. At this point, the first OWL should be nominally aligned. The same process could be employed to align the second OWL on the basis of its Time Stamp information as well.

In another embodiment, the OWLs could feed back alignment information using the “Sample #” field 82 and “Last Sample Seen” field 84 in much the same way. Each control packet will contain an updated sample number and each OWL will “remember” its beam position corresponding to that sample number. The receiving OWL will update its own control packet with a “Last Sample Seen” value once it receives a control packet, much as the “Your X” and “Your Y” fields are updated in the above described embodiment. When an OWL receives a control packet having a valid “Last Sample Seen” value, the OWL will re-align its beam to correspond to the position of that Sample number. Likewise, the OWL will update its own Last Sample Seen field with the Sample number received in the incoming control packet.

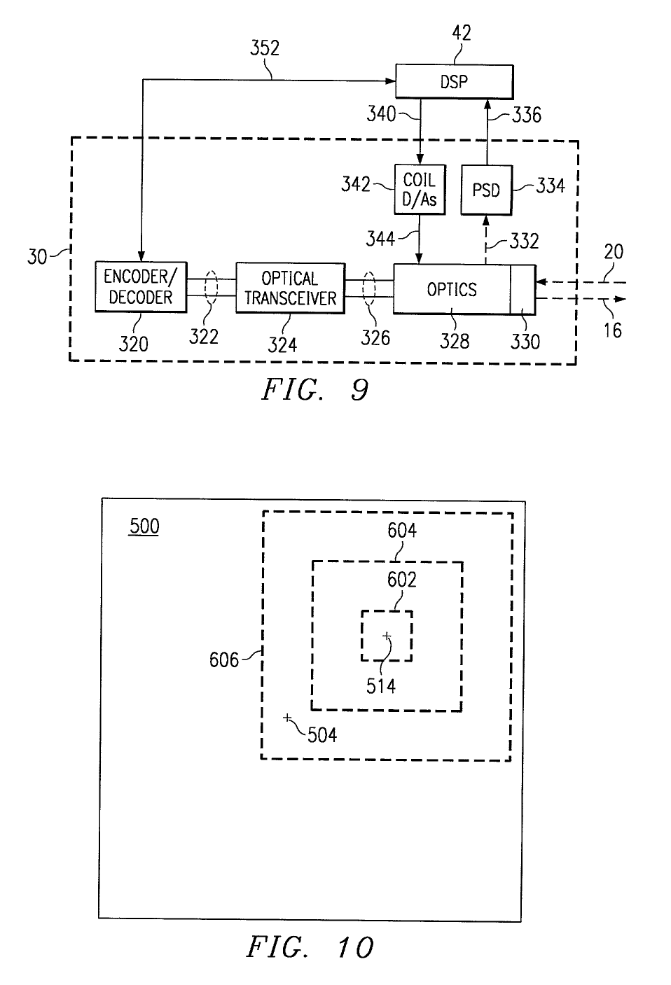

One embodiment of an optical module 30 is provided in FIG. 9. The module includes an Encoder/Decoder Unit 320, coupled by a two-way Data Link 322 to an Optical Transceiver Unit (OTU) 324. The OTU 324 acts as an electrical to light and light to electrical converter. It contains a light source, such as a laser or light emitting diode, control electronics for the light source, a photo-detector for converting the received light to electrical signals and amplifiers to boost the electrical strength to that compatible with the decoder.

The OTU 324 can also be of conventional design. For example, a TTC-2C13 available from TrueLight Corporation of Taiwan, R.O.C., provides an advantageous and low cost optical transceiver unit, requiring only a single +5V power supply, consuming low power, and providing high bandwidth. However, it should be noted that OTU units of conventional design can provide less than optimal performance, since such units are typically designed for transmitting and receiving light from fibers. This results in three problems that should be noted by the designer. First, light is contained in such units and is thus not subject to the same eye safety considerations as open air optical systems such as the present invention. Consequently, such units may have excessively high power. Second, light is transmitted to a fiber and thus has optical requirements that are different from those where collimation is required, as in embodiments of the present invention. Third, light is received by such units from a narrow fiber, and therefore such units usually have smaller detector areas than desired for embodiments of the present invention. Accordingly, it is considered preferable to assemble a transceiver having a photodiode and optical design such that the maximum amount of light is collected from a given field of view. This requires as large a photodiode as possible, with the upper limit being influenced by factors such as photodiode speed and cost. In any event source, a preferred light source is a vertical cavity surface emitting laser, sometimes referred to as a VCSEL laser diode. Such laser diodes have, advantageously, a substantially circular cross-section emission beam, a narrow emission cone and less dependence on temperature.

The Optical Transceiver Unit 324 is coupled by a two-way data link 326 to Optics 328. The Optics 328 contains optical components for collimating or focusing the outgoing light beam 16 from the transceiver, a micro-mirror controlled by, e.g., electromagnetic coils, for directing the collimated light in the direction of a second OWL (not shown), with which OWL is in communication, and receiving optics to concentrate the light received from the second OWL on a transceiver photodetector included in the Optics 328. The receiving optics can include a control mirror, either flat or curved, to direct the light to the photodetector. Auxiliary photo detectors can be provided adjacent to the main photodetector for light detection in connection with a control subsystem (not shown), for controlling the control mirror, and maximize the light capture at the photodetector. The Optics 328 may also contain a spectral filter 330 to filter ambient light from the incoming signal light 20. The Optics 328 is preferably, but need not be a micro-mirror. Any controllable beam steering device can be used that changes the direction of the light beam without changing the orientation of the light emitter. In addition, a basic function of the Optics 328 is that it sufficiently collimates the light beam that will (1) substantially fit within the micro-mirror reflecting area, and (2) preserve the minimum detectable power density over the distance of the link. Laser diodes generally meet these criteria, and as such are preferred. However, light emitting diodes (LEDs) and other light sources can be made to satisfy these criteria as well.

For optical wireless links across large distances where the highest possible optical power density at the receiver is needed for robust transmission, the optical portion of the preferred embodiments should preferably be selected to achieve a divergence of less than 0.5 mrad, which is to be contrasted with the prior art system that have divergences in the range of 2.5 mrad. The divergence of less than 0.5 mrad results in an optical density greater than 25 times the optical density of the prior art systems, which, for the same received optical power density corresponds to 5 or more times longer range.

The optical receiver portion of this embodiment should be selected to have an intermediate size, preferably having a diameter in the range of 0.5 millimeter (mm) to 1 centimeter (cm). If the diameter is much smaller than 0.5 mm, it may be difficult to collect enough of the light directed on the receiver. On the other hand, if the diameter is much larger than 1 cm, the responsiveness of the detector may diminish to the point where the performance of the system is compromised.

It should also be understood that more than one Optical Transceiver Unit 324 may be provided in some embodiments, for example to provide multiple wavelengths to transmit information across a single link, in order to increase the bandwidth of a given OWL link. This involves generating light beams having multiple wavelengths and collecting and separating these separate light beams. Numerous apparatus and methods are taught in co-pending patent application______ (TI-31429), filed concurrently herewith and incorporated herein by reference.

The Optics 328 are coupled by an optical path 332 to a Position Sensitive Detector (“PSD”) 334. The PSD 334 measures the angular deflection of the micro-mirror in two planes. This can be accomplished by detecting the position of a spot of light on a sensor in the PSD 334. The analog signals representing these angular deflections are converted into signals and sent on lines 336 to a Digital Signal Processor (“DSP”) 42 for closed loop control of the micro-mirror in Optics 328. PSDs are well known in the art, and PSD 334 may be any of a variety of types, including a single diode Si PSD, CMOS photo-detector array, and the like. All that is required of PSD 334 is that it sense, in two directions, the position of a spot of light impinging thereon, and provide as outputs digital signals representative of such position. However, note that the use of analog control signals is not required in the practice of the present invention. Other known control signal approaches can be used. For example, pulse-width modulation may be used to provide such control. Such choices of control system are well within the purview of those of ordinary skill in this art. A preferable approach to micro-mirror position detection is to employ sensors on the actual micro-mirror itself, as described in greater detail in co-pending and commonly assigned patent applications 60/233,851 (“Packaged Mirror with In Package Feedback”) and 60/234,081 (“Optical Wireless Networking with Direct Beam Pointing”), which applications are incorporated herein by reference.

In addition to receiving the signal lines 336 from the PSD 334, the DSP 42 sends coil control signals on lines 340 to a set of coil digital to analog converters (“D/As”) 342. The D/As 342 are, in turn, connected by way of lines 344 to a corresponding set of coils in Optics 328. Finally, the DSP 42 is connected via line 352 to send and receive OAM data to/from Encoder/Decoder 320. The DSP 42 operates as a link control. It controls the micro-mirror deflections by controlling the coil currents through the D/As 342. Information on the instantaneous micro-mirror deflections is received from the PSD 334 for optional closed loop control. The DSP 42 also exchanges information to the second OWL to orient the beam steering micro-mirror in the proper direction for the link to be established and maintained. The DSP may also exchange OAM information with the second OWL across the optical link maintained by Optical Module 328. DSP 42 may be any suitable DSP, of which many are commercially available. Preferably, the DSP is the DSP provided for by control logic 26, as discussed above, although a second distinct DSP could optionally be used. In addition, note that a single processor may control multiple OWL links. This capability can be very valuable for use in a network hub, where multiple links originate or terminate in a single physical network switch. A single DSP could provide a very cost efficient control facility in such cases. In all such cases, the requirements for this processor are a sufficiently high instruction processing rate in order to control the specified number of micro-mirrors, and a sufficient number of input/output (“I/O”) ports to manage control subsystem devices and peripheral functions.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of re-acquiring alignment of an optical wireless device, the optical wireless device transmitting information over a light beam and storing orientation information for a last known good alignment position for the light beam, the method comprising:
detecting a disruption of reception of an information transmitting light beam, when the light beam is at a first alignment position;
positioning the light beam to the last known good alignment position;
sweeping the light beam through a first pre-defined re-acquisition pattern; and
periodically transmitting position information over the light beam during the sweeping step.

2. The method of claim 1 further comprising:
waiting a pre-determined period of time after detecting the loss of alignment prior to positioning the light beam to the last known good alignment position; and
leaving the light beam at the first alignment position and resuming communication on the light beam if the disruption of reception of the information transmitting light beam ends during the pre-determined period of time.

3. The method of claim 1 further comprising:
positioning the light beam to a default alignment position;
sweeping the light beam through a second pre-defined re-acquisition pattern; and
periodically transmitting position information over the light beam during the sweeping of the second pre-defined re-acquisition pattern.

4. The method of claim 1 wherein the last known good alignment position is received from a remote optical wireless device.

5. The method of claim 1 wherein the last known good alignment position comprises x and y coordinate values.

6. The method of claim 1 wherein the last known good alignment position comprises radius and angle information.

7. The method of claim 1 wherein the last known good alignment position comprises a time stamp.

8. The method of claim 1 wherein at least one of said first and second re-acquisition patterns is an expanding spiral.

9. The method of claim 1 wherein the optical wireless device has a field of view and the first pre-defined re-acquisition pattern covers a limited portion of the field of view and the second pre-defined re-acquisition pattern covers substantially the full field of view.

10. The method of claim 1 wherein the first reacquisition pattern consists of repeated spirals with increasing maximum radii.

11. An optical wireless link comprising:
a light beam transmitter, configured to transmit an information bearing light beam;
a light beam steering device coupled to the light beam transmitter;
a light beam orientation detector coupled to the light beam transmitter and the light beam steering device and configured to detect the alignment of the light beam;
a photodetector configured to detect an incoming information bearing light beam;
a memory coupled to the light beam orientation detector and configured to store last known good alignment position data;
control circuit coupled to the photodetector and the light beam steering device;
wherein the light beam steering device will position the light beam to the last known good alignment position in response to the photodetector detecting the disruption of the incoming information bearing light beam;
wherein the light beam steering device will further sweep the light beam through a pre-defined re-acquisition pattern starting at the last known good alignment position;
and further wherein the light beam transmitter control circuit will periodically transmit light beam alignment position information received from the light beam position detector while the light beam is swept through the pre-defined re-acquisition pattern.

12. The optical wireless link of claim 11 wherein the light beam steering device is a micro-mirror.

13. The optical wireless link of claim 11 further comprising a timer configured to count down a pre-defined time period and wherein the light beam steering device will position the light beam to the last known good alignment position only if the disruption of the incoming light beam does not cease prior to the timer counting down the pre-defined time period.

14. The optical wireless link of claim 11 wherein the light beam steering device is further configured to position the light beam to a default position and to sweep the light beam through a second pre-defined acquisition pattern starting at the default position.

15. A method of re-acquiring alignment between two optical wireless links comprising:
detecting at a first optical wireless link and a second optical wireless link the disruption of a first and second incoming light beam, respectively;
positioning the first light beam to a last known good alignment position for the first light beam and the second light beam to a last known good alignment position for the second light beam;
sweeping the first and second light beams through a re-acquisition alignment pattern while transmitting position information for the first and second light beams over the first and second light beams, respectively;
upon detecting the first light beam at the second optical wireless device, transmitting the position information received from the first optical wireless device back to the first optical wireless device as a first updated last known good alignment position;
upon detecting the second light beam at the first optical wireless device, transmitting the position information received from the second optical wireless device back to the second optical wireless device as a second updated last known good alignment position; and
aligning the first and second light beams to the first and second updated last known good alignment positions, respectively.

16. The method of claim 15 further comprising:
waiting a pre-determined period of time after the detecting step and continuing with the steps of claim 15 only if the disruption of the first and second signal-bearing incoming light beams continues past the pre-determined time period.

17. The method of claim 15 wherein the last known good alignment position information is transmitted over the light beam periodically.

18. The method of claim 15 wherein the pre-determined period of time is a variable time period.

19. The method of claim 15 wherein the position information is transmitted as a link level protocol packet.

20. The method of claim 15 further comprising:
communicating network data between the first and second optical wireless devices after aligning the first and second light beams to the first and second updated last known good alignment positions.
